(19) United States
(12) Patent Application Publication
(10) Pub. No.: US 2013/0269968 A1
(43) Pub. Date: Oct. 17, 2013

(54) Wire Connecting Device for Solar Cell

(71) Applicant: Wei Hui Wang, CIXI NINGBO CITY (CN)

(72) Inventor: Wei Hui Wang, CIXI NINGBO CITY (CN)

(21) Appl. No.: 13/543,873

(22) Filed: Jul. 8, 2012

(30) Foreign Application Priority Data
Apr. 12, 2012 (CN) 201220151202.2

(51) Int. Cl. H02G 3/08

(52) U.S. Cl. 174/50

(57) ABSTRACT

A wire connecting device for solar cell including a casing, and an electric conductive element provided in the casing. In order to solve the relatively high temperature problem of the wire connecting device after a long period of usage, the wire connecting device is advanced and modified to provide a thermal conductive gluing element at the casing to encircle around the electric conductive element for conducting heat away from the electric conductive element. The thermal conductive gluing element encircled around the electric conductive element not only conducts heat transferred from the electric conductive element to the casing to reduce the heat accumulation of the electric conductive element, but also provides an effective sealing effect to prevent the occurrence of high temperature of the wire connecting device for solar cell after a long period of usage.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to photovoltaic arrangement technology, and more particularly to a wire connecting device for a solar cell.

2. Description of Related Arts

A wire connecting device for solar cell, which is mounted on a photovoltaic cell panel, is a component used for electric-conductive connection. Conductive elements are provided in the wire connecting device for connecting conductors having conductive capability with electric power lines through which the electricity produced by the solar cells is transmitted to an electric network.

The conventional wire connecting device has a low heat dissipating effect after a relatively long period of time of operation and thus results in a failure in meeting a requirement of a high-power solar cell arrangement. In addition, a temperature of the wire connecting device after usage is relatively high that makes the sealing performance of the wire connecting device difficult to pass the IP67 test after a long period of operation.

Accordingly, it is an urgent need to person skilled in this art to have a solution to the relatively high temperature problem of the wire connecting device after a long period of usage.

### SUMMARY OF THE PRESENT INVENTION

A main object of the present invention is to provide a wire connecting device for solar cell which can solve the relatively high temperature problem of the wire connecting device after a long period of usage by means of the structural design of the present invention.

Additional advantages and features of the invention will become apparent from the description which follows, and may be realized by means of the instrumentalities and combinations particular point out in the appended claims.

According to the present invention, the foregoing and other objects and advantages are attained by providing a wire connecting device for solar cell, which comprises a casing, an electric conductive element provided in the casing, and a thermal conductive gluing element provided at the casing encircling the electric conductive element for conducting heat from the electric conductive element.

In a preferred embodiment, the electric conductive element is constructed to have a sheet type structure.

In another preferred embodiment, a cap is provided on the casing for packaging the electric conductive element and the thermal conductive gluing element.

The present invention provides a wire connecting device for solar cell comprising a casing, and an electric conductive element provided in the casing. In order to solve the relatively high temperature problem of the wire connecting device after a long period of usage, the current wire connecting device for solar cell is optimized and modified to provide a thermal conductive gluing element at the casing to encircle around the electric conductive element for conducting heat away from the electric conductive element, according to a preferred embodiment of the present invention. The thermal conductive gluing element is also called thermal conductive silicon gel. In which organic silicon gel, as a main ingredient, is added and mixed with polymer material, such as filling material, thermal conductive material, and etc., to produce the silicon gel having a good thermal conduction and electric insulation performance. The thermal conductive glue is provided at the casing encircling around the electric conductive element for not only conducting heat transferred from the electric conductive element to the casing to reduce the heat accumulation of the electric conductive element, but also providing an effective sealing effect to prevent the occurrence of high temperature of the wire connecting device for the solar cell after a long period of usage.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a casing of a wire connecting device for solar cell according to a preferred embodiment of the present invention.

FIG. 2 is a perspective view of a conductive element of the wire connecting device for solar cell according to the preferred embodiment of the present invention.

FIG. 3 is a perspective view of a cap of the wire connecting device for solar cell according to the preferred embodiment of the present invention.

### DETAILED DESCRIPTION OF THE PREFERRED EMBODIMENT

The following description is disclosed to enable any person skilled in the art to make and use the present invention. Preferable embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Embodiments of the present invention are illustrated referring to the accompanying drawings. It should be recognized that the drawings are simplifying schematic views illustrating the spirit of the present invention. Thus the relevant structure of the present invention depicted in the drawings is not shown with the same number of elements, shape, and dimension of an actual product. It is expressly intended that the figures, numbers, and proportion of the elements are not limited by the drawings.

The principle of the present invention is to provide a wire connecting device for solar cell to solve the relatively high temperature problem of the wire connecting device after a long period of usage by providing a thermal conductive gluing element in a casing.

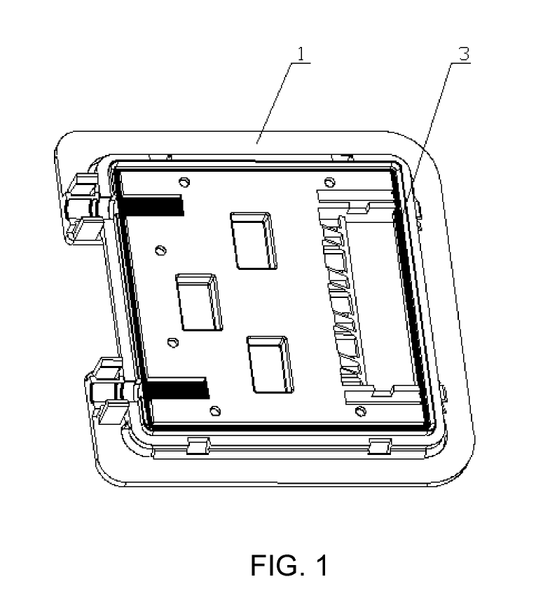

Referring to FIG. 1 of the drawings, a casing according to a preferred embodiment of the present invention is illustrated.

The present invention provides a wire connecting device for a solar cell comprising a casing 1, and an electric conductive element 2 provided in the casing 1. In order to solve the relatively high temperature problem of the wire connecting device after a long period of usage, the current wire connecting device for solar cell is advanced and modified to provide a thermal conductive gluing element at the casing 1 to encircle around the electric conductive element 2 for conducting heat away from the electric conductive element 2 according to the preferred embodiment of the present invention.

The thermal conductive gluing element is also called thermal conductive silicon gel, wherein organic silicon gel, as a main ingredient, is added and mixed with polymer material, such as filling material, thermal conductive material, and etc., to produce the silicon gel having a good thermal conduction and electric insulation performance. The thermal conductive gluing element 3 is provided at the casing 1 and encircled around the electric conductive element 2 for not only conducting heat transferred from the electric conductive element 2 to the casing 1 to reduce the heat accumulation of the electric conductive element 2, but also providing an effective sealing effect to prevent the occurrence of high temperature of the wire connecting device for solar cell after a long period of usage.

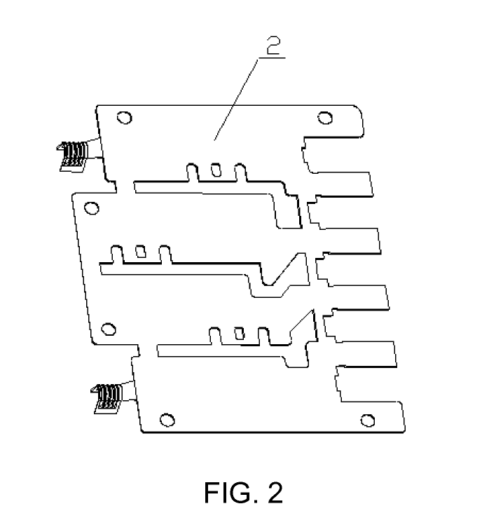

Referring to FIG. 2 of the drawings, the electric conductive element according to the preferred embodiment of the present invention is illustrated.

In order to further reduce the heat accumulation of the electric conductive element 2, the electric conductive element 2 in this preferred embodiment of the present invention is embodied as an electric conductive element having a sheet like structure. It is commonly known that a relatively larger surface area of an element which can produce heat by itself (the electric conductive element of the present invention) provides a larger heat dissipating area to reduce the heat accumulation. Therefore, the electric conductive element of the present invention is constructed to have a sheet like structure for further enhancing the heat dissipating effect of the present invention.

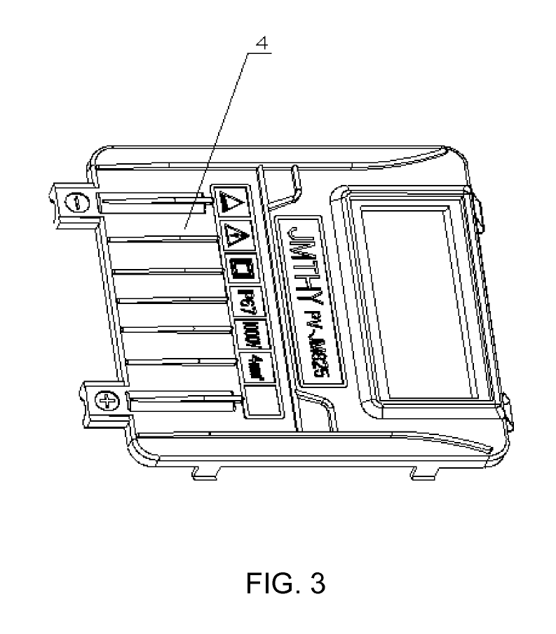

Referring to FIG. 3 of the drawings, a cap according to a preferred embodiment of the present invention is illustrated.

More specifically, similar to a conventional art, the casing 1 of this preferred embodiment of the present invention also provides a cap 4. According to the preferred embodiment of the present invention, the cap is used for packaging the electric conductive element 2 and the thermal conductive gluing element 3.

In addition to the above disclosed structure, the wire connecting device of the present invention is configured to comprise the casing 1, the thermal conductive gluing element 3, the electric conductive element 2, a diode, the cap 4, and a sealing cover. An external conductive wire is electrically connected to the electric conductive element 2. The diode is welded to the electric conductive element 2. Then, the electric conductive element 2 is integrally installed in the casing 1. Then, the thermal conductive gluing element 3 is provided in the casing 1. When a bus bar is welded with the electric conductive element 2 and is covered by the sealing cover upon installation by a user, the assembled arrangement can thus be subject to be used.

Although a preferred embodiment of the present invention is disclosed in the above description and accompanying drawings, it should be understood that a variety of additions, modifications, and replacement can be introduced into the preferred embodiment without departing from the spirit and scope of the claims of the present invention. Person of ordinary skill in the art will recognized that various of modifications may be made to the shape, structure, arrangement, proportion, material, element and parts of the present invention. The embodiment of the present invention as shown in the drawings and described above is exemplary only and not intended to be limiting. The scope of the present invention is defined by the appending claims incorporating the equivalences thereof and is not limited by the description.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wire connecting device for solar cell, comprising:
a casing;
an electric conductive element provided in said casing; and
a thermal conductive gluing element provided at said casing, encircling said electric conductive element for conducting heat away from said electric conductive element.

2. The wire connecting device for solar cell, as recited in claim 1, wherein said electric conductive element is constructed to have a sheet like structure.

3. The wire connecting device for solar cell, as recited in claim 1, further comprising a cap provided on said casing for packaging said electric conductive element and said thermal conductive gluing element.
